(19) United States
(12) Patent Application Publication
(10) Pub. No.: US 2017/0277421 A1
(43) Pub. Date: Sep. 28, 2017

(54) METHOD AND MOBILE DEVICE FOR ADJUSTING MULTIMEDIA

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/348,685

(22) Filed: Nov. 10, 2016

Related U.S. Application Data
(63) Continuation of application No. PCT/CN2016/096402, filed on Aug. 23, 2016.

(30) Foreign Application Priority Data
Mar. 25, 2016 (CN) 2016101804678

(51) Int. Cl. G06F 3/0488; G06F 3/16; G06F 3/0484

(52) U.S. Cl. CPC G06F 3/04883; G06F 3/04847; G06F 3/165; G06F 3/04845; G06F 3/04886

(57) ABSTRACT

Disclosed are a method and mobile device for adjusting multimedia. The method for adjusting multimedia comprises: detecting an operation information of a user at an edge touch area of a side border of the mobile device in a state that the mobile device plays multimedia; analyzing a multimedia adjusting instruction corresponding to the detected operation information according to a preset corresponding relation between the operation information and the multimedia adjusting instruction; and adjusting the multimedia according to the analyzed multimedia adjusting instruction, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved.

### CROSS REFERENCE TO RELATED APPLICATIONS

This application is a continuation of International Application No. PCT/CN2016/096402, filed on Aug. 23, 2016, which is based upon and claims priority to Chinese Patent Application No. 2016101804678, filed on Mar. 25, 2016, the entire contents of which are incorporated herein by reference.

### TECHNICAL FIELD

The present disclosure relates to the technical field of communications, and particularly relates to a method and mobile device for adjusting multimedia.

### BACKGROUND

A mobile device brings a lot of convenience to people's lives as a multifunctional terminal device. For example, people can carry out mobile payment without carrying a large amount of cash or bank cards, surf the Internet to search desired information and browse latest news at any time and any place and the like using the mobile device. The mobile device is also a multimedia terminal, and can be used for browsing pictures and files, listening to music, watching video, playing network games and the like, so that people can learn, relax and entertain in time.

Multimedia information including video, audio, pictures, characters and the like can be played or displayed by the mobile device such as a mobile phone, a tablet computer and the like. Because the mobile device is convenient to carry, users watch multimedia with the mobile device more and more. Taking video as an example, two kinds of video can be watched in the mobile device. One is video stored locally in the mobile device, e.g., video fragments recorded by a camera of the mobile device, while the other one is network video played on line by the mobile device connected with a wireless network. As the network speed of mobile data is increasingly high and the service fee of the mobile network continuously declines, the time for watching the network video with the mobile device is continuously increased.

At present, when the multimedia information is played by the mobile device, multimedia can be adjusted via a screen of the mobile device. For example, a volume of the played video or audio is adjusted via a virtual volume adjusting icon on the screen of the mobile device, pictures or characters are zoomed in or out by expansion or retraction of two fingers on the screen of the mobile device.

In the process of implementing the present disclosure, the inventor discovers that the prior art at least has the following problems:

1: when the multimedia is played by the mobile device, the adjusting operation cannot be accomplished while the mobile device is held by one hand, so the mobile device is inconvenient to use.

2: the screen is inevitably blocked by adjustment on the screen of the mobile device, and the watching effect is thus influenced.

### SUMMARY

In view of this, the present disclosure provides a method and mobile device for adjusting multimedia to solve the problems of inconvenient operation and screen blocking when multimedia is adjusted via the screen of the mobile device in the prior art.

On one aspect, an embodiment of the present disclosure provides a method for adjusting multimedia, applied to a mobile device, including: detecting an operation information of a user at an edge touch area of a side border of the mobile device in a state that the mobile device plays multimedia; analyzing a multimedia adjusting instruction corresponding to the detected operation information according to a preset corresponding relation between the operation information and the multimedia adjusting instruction; and adjusting the multimedia according to the analyzed multimedia adjusting instruction.

According to the above aspect and any possible implementation way, an implementation way is further provided, wherein the adjusting the multimedia according to the analyzed multimedia adjusting instruction includes: adjusting a volume of the multimedia according to the analyzed multimedia adjusting instruction, adjusting a brightness of the screen for displaying the multimedia according to the analyzed multimedia adjusting instruction, or adjusting a screen display size of the multimedia according to the analyzed multimedia adjusting instruction.

According to the above aspect and any possible implementation way, an implementation way is further provided, wherein the method further includes: presetting the corresponding relation between the operation information and the multimedia adjusting instruction.

According to the above aspect and any possible implementation way, an implementation way is further provided, wherein before analyzing a multimedia adjusting instruction corresponding to the detected operation information according to a preset corresponding relation between the operation information and the multimedia adjusting instruction, the method further includes: judging a current screen direction of the mobile device, wherein the screen direction includes a landscape screen direction and a portrait screen direction; and selecting, according to a judgment result, a corresponding relation between the operation information and the multimedia adjusting instruction corresponding to the current screen direction as an analysis basis.

According to the above aspect and any possible implementation way, an implementation way is further provided, wherein the operation information is clicking at a preset position or pressing at the preset position, or sliding.

According to the above aspect and any possible implementation way, an implementation way is further provided, wherein the multimedia is video, audio, pictures or characters.

Any of the above technical solutions has the following beneficial effects:

According to the method for adjusting multimedia of the embodiment of the present disclosure, the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved.

On a further aspect, an embodiment of the present disclosure provides a mobile device, including: a processor; and a memory, used for storing an instructions executable by the processor; wherein the processor is configured to: detect an operation information of a user at an edge touch area of a side border of the mobile device in a state that the mobile device plays multimedia; analyze a multimedia adjusting instruction corresponding to the detected operation information according to a preset corresponding relation between the operation information and the multimedia adjusting instruction; and adjust the multimedia according to the analyzed multimedia adjusting instruction.

According to the above aspect and any possible implementation way, an implementation way is further provided, wherein the mobile device is a mobile phone or a tablet computer.

Any of the above technical solutions has the following beneficial effects:

The mobile device of the embodiment of the present disclosure can execute the aforementioned methods for adjusting multimedia, and the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved.

On a further aspect, an embodiment of the present disclosure further provides a non-transient computer readable storage medium, which stores computer executable instructions, the computer executable instructions are used for: detecting an operation information of a user at an edge touch area of a side border of the mobile device in a state that the mobile device plays multimedia; analyzing a multimedia adjusting instruction corresponding to the detected operation information according to a preset corresponding relation between the operation information and the multimedia adjusting instruction; and adjusting the multimedia according to the analyzed multimedia adjusting instruction.

According to the non-transient computer readable storage medium of the embodiment of the present disclosure, the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved.

On a further aspect, an embodiment of the present disclosure provides a computer program product, the computer program product includes a computer program stored on a non-transient computer readable storage medium, the computer program includes program instructions, and when the program instructions are executed by a computer, the computer executes the above methods.

According to the computer program product of the embodiment of the present disclosure, the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the user experience is promoted, and the user satisfaction is improved.

### BRIEF DESCRIPTION OF THE DRAWINGS

One or more embodiments are illustrated by way of example via figures in corresponding drawings, these illustrations do not limit the embodiments, components with the same reference numerical signs in the drawings represent similar elements, and the figures in the drawings do not have proportional limitations unless otherwise specified.

FIG. 1 is a flow schematic diagram of embodiment 1 of a method for adjusting multimedia provided by some embodiments of the present disclosure;

FIG. 2 is a schematic diagram of a side border of a mobile phone in some embodiments of the present disclosure;

FIG. 3 is a flow schematic diagram of embodiment 2 of a method for adjusting multimedia provided by some embodiments of the present disclosure;

FIG. 4 is a flow schematic diagram of embodiment 3 of a method for adjusting multimedia provided by some embodiments of the present disclosure;

FIG. 5 is a first functional block diagram of an apparatus for adjusting multimedia provided by some embodiments of the present disclosure;

FIG. 6 is a second functional block diagram of an apparatus for adjusting multimedia provided by some embodiments of the present disclosure;

FIG. 7 is a third functional block diagram of an apparatus for adjusting multimedia provided by some embodiments of the present disclosure;

FIG. 8 is a structural schematic diagram of mobile device provided by some embodiments of the present disclosure.

### DETAILED DESCRIPTION

Preferred embodiments of the present disclosure will be illustrated below in combination with the accompanying drawings. It should be understood that the preferred embodiments described herein are merely used for illustrating and interpreting the present disclosure, rather than limiting the present disclosure.

In order to better understand the technical solutions of the present disclosure, the embodiments of the present disclosure will be described in detail below in combination with the accompanying drawings.

It should be clear that the described embodiments are merely part of, not all of the embodiments of the present disclosure. Based on the embodiments in the present disclosure, all other embodiments obtained by those of ordinary skill in the art without any creative effort shall be within the protection scope of the present disclosure.

The terms used in the embodiments of the present disclosure are for describing specific embodiments only, rather than limiting the present disclosure. Singular forms “one”, “said” and “the” used in the embodiments and the appended claims of the present disclosure also intend to include plural forms, unless the context clearly expresses other meanings.

It should be understood that the term “and/or” used in the present disclosure is merely an association relation for describing associated objects, and can express three relations, for example, A and/or B can express: single A, both A and B, and single B. In addition, the symbol “/” herein generally expresses an “or” relation between consecutive associated objects.

It should be understood that XXX may be described by adopting the terms including first, second and third in the embodiments of the present disclosure, but the XXX should not be limited to these terms. These terms are merely used for distinguishing the XXX from one another. For example, the first XXX may also be referred to as the second XXX, and similarly, the second XXX may also be referred to as the first XXX, without departing from the scope of the embodiments of the present disclosure.

Upon the context, the word “if” used herein can be interpreted as “at the time of . . . ” or “when . . . ” or “responding to determining” or “responding to detecting”. Similarly, upon the context, the phrase “if determining” or “if detecting (the stated condition or event)” can be interpreted as “when determining” or “responding to determining” or “when detecting (the stated condition or event)” or “responding to detecting (the stated condition or event)”.

The multimedia adjusting method and the device for adjusting multimedia in the embodiments of the present disclosure below can be applied to mobile device.

### Embodiment 1

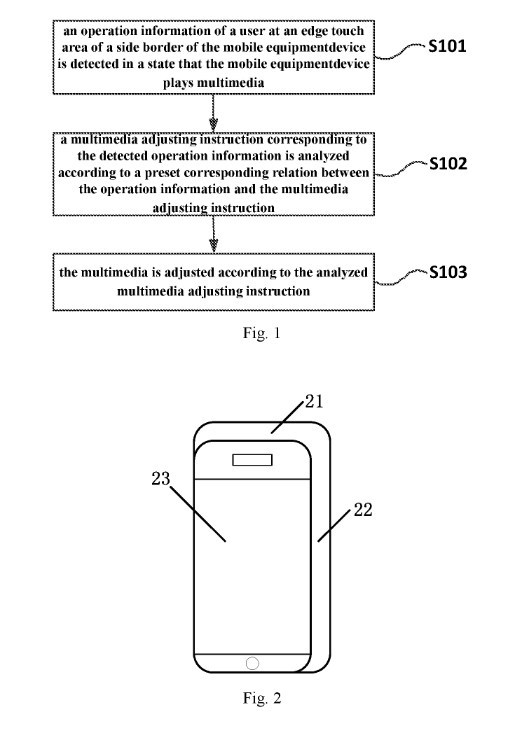

The embodiment of the present disclosure gives a method for adjusting multimedia, which is applied to a mobile device. Please refer to FIG. 1, which is a flow schematic diagram of a method for adjusting multimedia provided by an embodiment of the present disclosure. As shown in FIG. 1, the method may include the following steps S101-S103.

S101, an operation information of a user at an edge touch area of a side border of the mobile device is detected in a state that the mobile device plays multimedia.

The multimedia may be video, audio, pictures, characters, etc. For example, watching movies, listening to music, browsing pictures, viewing files and the like all belong to playing the multimedia.

It should be noted that the mobile device involved in the embodiments of the present disclosure may include but not limited to a personal computer (PC), a personal digital assistant (PDA), a wireless handheld device, a notebook computer, a tablet computer, a mobile phone, an MP3 player, an MP4 player, etc.

In the embodiment of the present disclosure, the edge touch area may be located at the side border of the mobile device. A mobile phone is taken as an example. FIG. 2 is a schematic diagram of a side border of a mobile phone in the embodiment of the present disclosure. As shown in FIG. 2, the side borders of the mobile phone include an upper border 21, a lower border (not shown in the figure), a left border (not shown in the figure) and a right border 22. The screen 23 of the mobile phone is located on the front side of the mobile phone. The edge touch area is located at the side border.

The operation information may be clicking at a preset position or pressing at the preset position, or sliding, etc. For example, when the right hand of the user holds a mobile phone, the thumb of the right hand slides on the right border of the mobile phone to adjust a volume of the video which is being played on the mobile device, for example, the thumb of the right hand slides up on the right border of the mobile phone to improve the volume and slides down to reduce the volume. The adjustment of audio is similar.

For another example, when the right hand of the user holds a mobile phone, the index finger of the right hand can click a preset position of the upper border of the mobile phone to adjust a screen brightness of the video which is being played on the mobile device. For example, when the index finger of the right hand clicks the left half part of the upper border of the mobile phone, the screen brightness is reduced; and when the index finger of the right hand clicks the right half part of the upper border of the mobile phone, the screen brightness is improved. The brightness adjustment of screen display of pictures, characters and the like is similar.

For a further example, when the right hand of the user holds a mobile phone, the thumb of the right hand can click the middle area of the right border of the mobile phone to switch the screen between full screen and full screen exit. If the screen is in a full screen state at present, when the thumb of the right hand of the user clicks the middle area of the right border of the mobile phone, the screen exits the full screen state; and if the screen is in a full screen exit state at present, when the thumb of the right hand of the user clicks the middle area of the right border of the mobile phone, the screen is switched to the full screen state.

Hence, the multimedia played by the mobile device is adjusted via the operation information of a user at an edge touch area of a side border of the mobile device, so that the adjusting operation can be accomplished while holding the mobile device by one hand, one-hand operation is thus realized, and the operation is convenient and fast. Meanwhile, the screen can be prevented from being blocked, and good watching effect is thus guaranteed.

S102, a multimedia adjusting instruction corresponding to the detected operation information is analyzed according to a preset corresponding relation between the operation information and the multimedia adjusting instruction.

The multimedia adjusting instruction is used for adjusting multimedia.

The corresponding relation between the operation information and the multimedia adjusting instruction is preset in the mobile device. The corresponding relation makes the operation at the edge touch area of the mobile device correspond to the instruction for adjusting multimedia, so that when receiving the operation information at the edge touch area, the mobile device can understand the intention of the user and correspondingly adjust the multimedia according to the intention of the user.

S103, the multimedia is adjusted according to the analyzed multimedia adjusting instruction.

In the embodiment of the present disclosure, the multimedia is adjusted according to the analyzed multimedia adjusting instruction may include: a volume of the multimedia is adjusted according to the analyzed multimedia adjusting instruction.

In the embodiment of the present disclosure, the multimedia is adjusted according to the analyzed multimedia adjusting instruction may include: a brightness of a screen for displaying the multimedia is adjusted according to the analyzed multimedia adjusting instruction.

In the embodiment of the present disclosure, the multimedia is adjusted according to the analyzed multimedia adjusting instruction may include: a screen display size of the multimedia is adjusted according to the analyzed multimedia adjusting instruction.

It should be noted that the execution main body of the above steps S101˜S103 may be an apparatus, the apparatus may be an application of the local device or a functional unit such as a plug-in or software development kit (SDK) and the like located in the application of the local device, and the embodiment of the present disclosure is not specially limited thereto.

It could be understood that the application may be a nativeApp installed on the device or a webApp of a browser on the device, and the embodiment of the present disclosure is not limited thereto.

According to the method for adjusting multimedia of the embodiment of the present disclosure, the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved.

### Embodiment 2

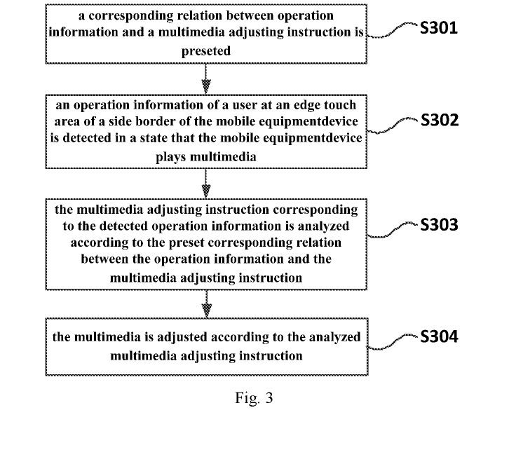

FIG. 3 is a flow schematic diagram of embodiment 2 of a method for adjusting multimedia provided by an embodiment of the present disclosure, and the method is applied to a mobile device. As shown in FIG. 3, the method for adjusting multimedia may include the following steps S301-S304 in this embodiment.

S301, a corresponding relation between operation information and a multimedia adjusting instruction is preseted.

In different application scenes, the operation habit of the user and the part facilitating the operation are different. Taking a mobile phone as an example, when the mobile phone is used in the landscape screen direction, the user habitually holds the mobile phone with double hands, the index fingers of the double hands at the moment can conveniently slid, click or press at the upper border of the landscape screen, while the thumbs of the double hands can conveniently slide or click at the lower border of the landscape screen. When the mobile phone is used in the portrait screen direction, the user habitually holds the mobile phone with the right hand, and the index finger of the right hand at the moment can conveniently slide at the right border of the mobile phone. Thus, different corresponding relations between the operation information and the multimedia adjusting instruction may be set in the mobile device for different application scenes.

In addition, even in the same application scene, different users may also have different operation habits. Thus, in the embodiment of the present disclosure, the mobile device can provide multiple corresponding relations between the operation information and the multimedia adjusting instruction, and a user can select a corresponding relation between the operation information and the multimedia adjusting instruction suitable for himself as defaulted one of his mobile device. That is to say, one way of presetting the corresponding relation between the operation information and the multimedia adjusting instruction may be as follows: the user selects a corresponding relation between the operation information and the multimedia adjusting instruction suitable for himself as defaulted one of his mobile device from multiple corresponding relations between the operation information and the multimedia adjusting instruction provided by the mobile device.

In the embodiment of the present disclosure, the user can also set the corresponding relation between the operation information and the multimedia adjusting instruction suitable for himself by interaction with the mobile device. For example, some users habitually carry out operation by clicking, while other users habitually carry out operation by sliding, even the users who all habitually carry out operation by clicking, some of them habitually clicking with thumbs, and some of them habitually clicking with index fingers or middle fingers, and all the users can set the corresponding relation between the operation information and the multimedia adjusting instruction suitable for themselves based on their own operation habits by interaction with the mobile device. In this way, the personalized requirements of different users can be sufficiently met, so that the use experience of the users can be further promoted.

S302, an operation information of a user at an edge touch area of a side border of the mobile device is detected in a state that the mobile device plays multimedia.

S303, the multimedia adjusting instruction corresponding to the detected operation information is analyzed according to the preset corresponding relation between the operation information and the multimedia adjusting instruction.

S304, the multimedia is adjusted according to the analyzed multimedia adjusting instruction.

According to the method for adjusting multimedia of the embodiment of the present disclosure, the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved. Moreover, in the method for adjusting multimedia of the embodiment of the present disclosure, the user can preset the corresponding relation between the operation information and the multimedia adjusting instruction according to his own operation habit, and then the personalized requirements of different users can be sufficiently met, so that the use experience of the user can be further promoted and the user satisfaction can be improved.

### Embodiment 3

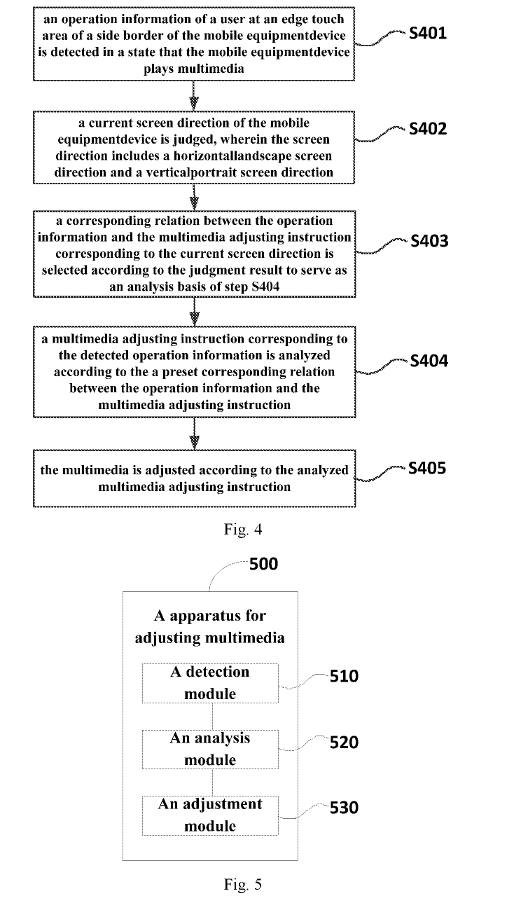

FIG. 4 is a flow schematic diagram of embodiment 3 of a method for adjusting multimedia provided by an embodiment of the present disclosure, and the method is applied to a mobile device. As shown in FIG. 4, the method for adjusting multimedia may include the following steps S401-S405 in this embodiment.

S401, an operation information of a user at an edge touch area of a side border of the mobile device is detected in a state that the mobile device plays multimedia.

S402, a current screen direction of the mobile device is judged, wherein the screen direction includes a landscape screen direction and a portrait screen direction.

When the screen directions of the mobile device are different, the positions of the edge touch area facilitating the operation of the user are different, and the habitually used fingers and the actions of the user are also different. For example, when the mobile phone is in the portrait screen direction, the edge touch area facilitating the operation of the user is at the upper area of the right border of the mobile device, the user habitually uses the thumb of the right hand, and the habitual and convenient action of the user at the moment is sliding. When the mobile phone is in the landscape screen direction (the left border or the right borer of the mobile phone at the moment is at the upper part), the edge touch area facilitating the operation of the user is at the middle area of the left border or the right border of the mobile device, the user habitually uses the index finger of the left hand or the right hand, and the habitual and convenient action of the user at the moment is fingerprint identification or clicking.

According to different screen directions, the corresponding relation between the operation information and the multimedia adjusting instruction, adapting to the specific screen direction, can be respectively set in the mobile terminal, that is, the corresponding relation between the operation information and the multimedia adjusting instruction suitable for being used in the landscape screen direction and that suitable for being used in the portrait screen direction. Then in the use process, the appropriate corresponding relation between the operation information and the multimedia adjusting instruction is selected according to the current specific screen direction. In this case, different demands of the user in specific application are considered more meticulously, so that the user can gain comfortable operation experience in different application scenes, and the user satisfaction can be further improved.

S403, a corresponding relation between the operation information and the multimedia adjusting instruction corresponding to the current screen direction is selected according to the judgment result as an analysis basis of step S404.

That is, if the current screen direction is a landscape screen direction, the corresponding relation between the operation information and the multimedia adjusting instruction corresponding to the landscape screen direction is selected; if the current screen direction is a portrait screen direction, the corresponding relation between the operation information and the multimedia adjusting instruction corresponding to the portrait screen direction is selected; thus, different requirements of the user in specific application are met.

S404, a multimedia adjusting instruction corresponding to the detected operation information is analyzed according to a preset corresponding relation between the operation information and the multimedia adjusting instruction.

S405, the multimedia is adjusted according to the analyzed multimedia adjusting instruction.

According to the method for adjusting multimedia of the embodiment of the present disclosure, the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved. Moreover, in the method for adjusting multimedia of the embodiment of the present disclosure, different requirements of the user in specific application are considered more meticulously by selecting the corresponding relation between the operation information and the multimedia adjusting instruction corresponding to the screen direction, so that the user can gain comfortable operation experience in different application scenes, and the user satisfaction is further improved.

Please refer to FIG. 5, which is a first functional block diagram of an apparatus for adjusting multimedia provided by an embodiment of the present disclosure. As shown in FIG. 5, the apparatus for adjusting multimedia 500 may include a detection module 510, an analysis module 520 and an adjustment module 530 in this embodiment. The detection module 510, the analysis module 520 and the adjustment module 530 can be connected in sequence.

The detection module 510 is used for detecting an operation information of a user at an edge touch area of a side border of mobile device in a state that the mobile device plays multimedia. The analysis module 520 is used for analyzing a multimedia adjusting instruction corresponding to the operation information detected by the detection module 510 according to a preset corresponding relation between the operation information and the multimedia adjusting instruction. The adjustment module 530 is used for adjusting the multimedia according to the multimedia adjusting instruction analyzed by the analysis module 520.

The multimedia may be video, audio, pictures, characters, etc. For example, watching movies, listening to music, browsing pictures, viewing files and the like all belong to playing the multimedia.

The operation information may be clicking at a preset position or pressing at the preset position, or sliding, etc.

In the embodiment of the present disclosure, the adjustment module 530 may include a volume adjustment unit. The volume adjustment unit is used for adjusting a volume of the multimedia according to the analyzed multimedia adjusting instruction.

In the embodiment of the present disclosure, the adjustment module 530 may include a brightness adjustment unit. The brightness adjustment unit is used for adjusting a brightness of a screen for displaying the multimedia according to the analyzed multimedia adjusting instruction.

In the embodiment of the present disclosure, the adjustment module 530 may include a size adjustment unit. The size adjustment unit is used for adjusting a screen display size of the multimedia according to the analyzed multimedia adjusting instruction.

Since the apparatus for adjusting multimedia in this embodiment can execute the method shown in FIG. 1, reference may be made to the relevant description of FIG. 1 for the parts not described in detail in this embodiment.

According to the apparatus for adjusting multimedia of the embodiment of the present disclosure, the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved.

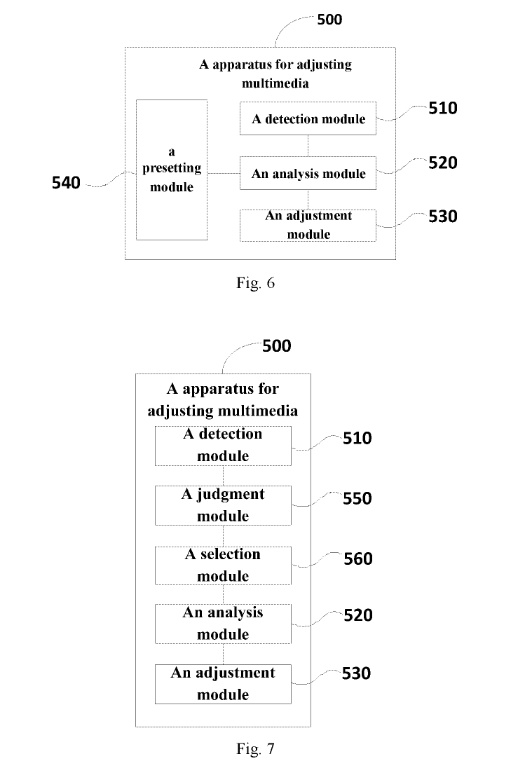

Please refer to FIG. 6, which is a second functional block diagram of an apparatus for adjusting multimedia provided by an embodiment of the present disclosure. As shown in FIG. 6, the apparatus for adjusting multimedia 500 may include a presetting module 540, a detection module 510, an analysis module 520 and an adjustment module 530 in this embodiment. The detection module 510, the analysis module 520 and the adjustment module 530 can be connected in sequence. The presetting module 540 is connected with the analysis module 520.

The detection module 510 is used for detecting an operation information of a user at an edge touch area of a side border of mobile device in a state that the mobile device plays multimedia. The analysis module 520 is used for analyzing a multimedia adjusting instruction corresponding to the operation information detected by the detection module 510 according to a preset corresponding relation between the operation information and the multimedia adjusting instruction. The adjustment module 530 is used for adjusting the multimedia according to the multimedia adjusting instruction analyzed by the analysis module 520. The presetting module 540 is used for presetting the corresponding relation between the operation information and the multimedia adjusting instruction.

Since the apparatus for adjusting multimedia in this embodiment can execute the method shown in FIG. 3, reference may be made to the relevant description of FIG. 3 for the parts not described in detail in this embodiment.

According to the apparatus for adjusting multimedia of the embodiment of the present disclosure, the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved. Moreover, in the apparatus for adjusting multimedia of the embodiment of the present disclosure, the user can preset the corresponding relation between the operation information and the multimedia adjusting instruction according to his own operation habit, and then the personalized requirements of different users can be sufficiently met, so that the use experience of the user can be further promoted and the user satisfaction can be improved.

Please refer to FIG. 7, which is a third functional block diagram of an apparatus for adjusting multimedia provided by an embodiment of the present disclosure. As shown in FIG. 7, the apparatus for adjusting multimedia 500 may include a detection module 510, a judgment module 550, a selection module 560, an analysis module 520 and an adjustment module 530 in this embodiment. The detection module 510, the judgment module 550, the selection module 560, the analysis module 520 and the adjustment module 530 can be connected in sequence.

The detection module 510 is used for detecting an operation information of a user at an edge touch area of a side border of mobile device in a state that the mobile device plays multimedia. The judgment module 550 is connected with the detection module 510, and is used for judging a current screen direction of the mobile device, wherein the screen direction includes a landscape screen direction and a portrait screen direction. The selection module 560 is used for selecting, according to a judgment result of the judgment module 550, a corresponding relation between the operation information and the multimedia adjusting instruction corresponding to the current screen direction as an analysis basis of the analysis module 520. The analysis module 520 is used for analyzing a multimedia adjusting instruction corresponding to the operation information detected by the detection module 510 according to the preset corresponding relation between the operation information and the multimedia adjusting instruction. The adjustment module 530 is used for adjusting the multimedia according to the multimedia adjusting instruction analyzed by the analysis module 520.

Since the apparatus for adjusting multimedia in this embodiment can execute the method shown in FIG. 4, reference may be made to the relevant description of FIG. 4 for the parts not described in detail in this embodiment.

According to the apparatus for adjusting multimedia of the embodiment of the present disclosure, the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved. Moreover, in the apparatus for adjusting multimedia of the embodiment of the present disclosure, different requirements of the user in specific application are considered more meticulously by selecting the corresponding relation between the operation information and the multimedia adjusting instruction corresponding to the screen direction, so that the user can gain comfortable operation experience in different application scenes, and the user satisfaction is further improved.

An embodiment of the present disclosure further provides a non-transient computer readable storage medium, and the non-transient computer readable storage medium stores computer executable instructions which can execute the method in any above method embodiment.

An embodiment of the present disclosure further provides mobile device, including a processor and a memory. The memory is used for storing a processor executable instruction; and the processor is configured to: detect an operation information of a user at an edge touch area of a side border of the mobile device in a state that the mobile device plays multimedia; analyze a multimedia adjusting instruction corresponding to the detected operation information according to a preset corresponding relation between the operation information and the multimedia adjusting instruction; and adjust the multimedia according to the analyzed multimedia adjusting instruction.

The mobile device may be a mobile phone or a tablet computer or the like.

In the embodiment of the present disclosure, the adjusting the multimedia according to the analyzed multimedia adjusting instruction may include: adjusting a volume of the multimedia according to the analyzed multimedia adjusting instruction, adjusting a brightness of a screen for displaying the multimedia according to the analyzed multimedia adjusting instruction, or adjusting a screen display size of the multimedia according to the analyzed video adjusting instruction.

In the embodiment of the present disclosure, the processor may also be configured to preset a corresponding relation between the operation information and the multimedia adjusting instruction.

In the embodiment of the present disclosure, before analyzing a multimedia adjusting instruction corresponding to the detected operation information according to a preset corresponding relation between the operation information and the multimedia adjusting instruction, the method may further include: judging the current screen direction of the mobile device, wherein the screen direction includes a landscape screen direction and a portrait screen direction; and selecting, according to a judgment result, a corresponding relation between the operation information and the multimedia adjusting instruction corresponding to the current screen direction as an analysis basis.

In the embodiment of the present disclosure, the operation information may be clicking at a preset position or pressing at the preset position, or sliding.

In the embodiment of the present disclosure, the multimedia may be video, audio, pictures or characters.

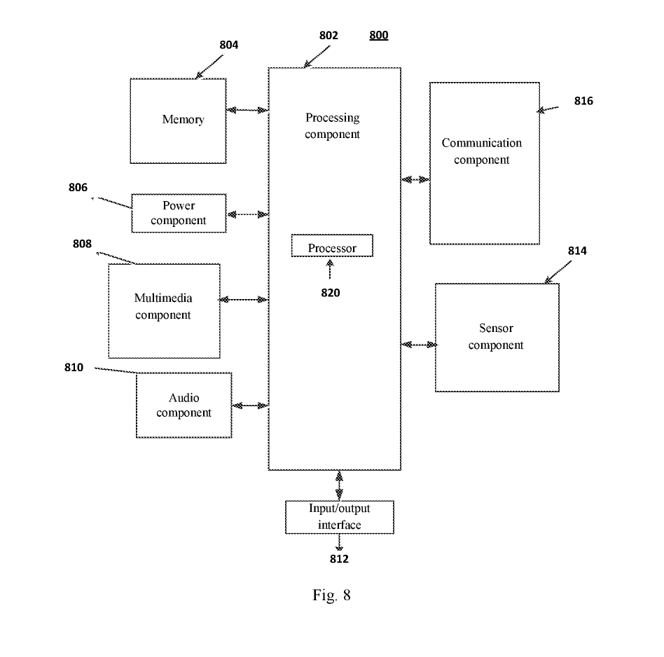

Please refer to FIG. 8, which is a structural schematic diagram of mobile device provided by an embodiment of the present disclosure. As shown in FIG. 8, the mobile device 800 may include one or more of the following components: a processing component 802, a memory 804, a power component 806, a multimedia component 808, an audio component 810, an input/output (I/O) interface 812, a sensor component 814 and a communication component 816.

The processing component 802 generally controls the overall operation of the mobile device 800, e.g., operation associated with display, telephone call, data communication, camera operation and recording operation. The processing component 802 may include one or more processors 820 for executing instructions to accomplish all of or part of the steps of the above mobile device application methods, specifically including: detecting operation information of a user at an edge touch area of a side border of the mobile device in a state that the mobile device plays multimedia; analyzing a multimedia adjusting instruction corresponding to the detected operation information according to a preset corresponding relation between the operation information and the multimedia adjusting instruction; and adjusting the multimedia according to the analyzed multimedia adjusting instruction. Moreover, the processing component 802 may include one or more modules, to facilitate the interaction between the processing component 802 and other components. For example, the processing component 802 may include a multimedia module, to facilitate the interaction between the multimedia component 808 and the processing component 802.

The memory 804 is configured to store various types of data to support the operation of the mobile device 800. The data examples include instructions, contact data, telephone directory data, messages, pictures, videos and the like of any application program or method operated on the mobile device 800. The memory 804 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 806 provides power for various components of the mobile device 800. The power component 806 may include a power management system, one or more power supplies, and other components associated with power generation, management and distribution for the mobile device 800.

The multimedia component 808 includes a screen for providing an output interface between the mobile device 800 and the user. In some embodiments, the screen may include a liquid crystal display (LCD) and a touch panel (TP). If the screen includes the touch panel, the screen may be realized as a touch screen to receive input signals from the user. The touch panel includes one or more touch sensors for sensing touch, sliding and gestures on the touch panel. The touch sensors can not only sense the boundary of the touch or sliding action, but also detect the duration and the pressure related to the touch or sliding operation. In some embodiments, the multimedia component 808 includes a front camera and/or a rear camera. When the mobile device 800 is in an operation mode, e.g., a shooting mode or a video mode, the front camera and/or the rear camera can receive external multimedia data. Each of the front camera and the rear camera may be a fixed optical lens system or has focal length and optical zooming capability.

The audio component 810 is configured to output and/or input audio signals. For example, the audio component 810 includes a microphone (MIC), and when the mobile device 800 is in an operation mode, e.g., a call mode, a recording mode and a speech recognition mode, the microphone is configured to receive external audio signals. The received audio signals can be further stored in the memory 804 or sent by the communication component 816. In some embodiments, the audio component 810 further includes a loudspeaker for outputting audio signals.

The I/O interface 812 provides an interface between the processing component 802 and a peripheral interface module, and the peripheral interface module may be a keyboard, a click wheel, a button and the like. The button may include but not limited to a home page button, a volume button, a start button and a locking button.

The sensor component 814 includes one or more sensors for providing state assessment on all aspects for the mobile device 800. For example, the sensor component 814 may detect an on/off state of the mobile device 800, and relative positions of components, e.g., the components are a display and a small keyboard of the mobile device 800; and the sensor component 814 may also detect the position change of the mobile device 800 or one component of the mobile device 800, existence or non-existence of contact between the user and the mobile device 800, orientation or acceleration/deceleration of the mobile device 800 and temperature change of the mobile device 800. The sensor component 814 may include a proximity sensor, which is configured to detect the presence of nearby objects in the absence of any physical contact. The sensor component 814 may further include an optical sensor, e.g., a CMOS or CCD image sensor used in imaging application. In some embodiments, the sensor component 814 may further include an acceleration sensor, a gyro sensor, a magnetic sensor, a pressure sensor or a temperature sensor.

The communication component 816 is configured to facilitate the communication between the mobile device 800 and other device in a wired or wireless mode. The mobile device 800 may be connected to a wireless network based on communication standards, e.g., Wi-Fi, 2G, 3G or 4G or their combination. In an exemplary embodiment, the communication component 816 receives broadcast signals or broadcast related information from an external broadcast management system via a broadcast channel. In an exemplary embodiment, the communication component 816 further includes a near field communication (NFC) module for promoting short-distance communication. For example, the NFC module may be realized on the basis of radio frequency identification (RFID) technology, infrared data association (IrDA) technology, ultra wide band (UWB) technology, Bluetooth (BT) technology and other technology.

In an exemplary embodiment, the mobile device 800 may be realized by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements, to execute the above methods.

The mobile device of the embodiment of the present disclosure can execute the aforementioned methods for adjusting multimedia, and the multimedia played by the mobile device is adjusted via the operation information of a user at an edge touch area of a side border of the mobile device, so that the user can accomplish the adjusting operation while holding the mobile device by one hand, one-hand operation is thus realized, the operation is convenient and fast, meanwhile, screen blocking is also avoided, good watching effect is guaranteed, then the use experience of the user is promoted, and the user satisfaction is improved.

Those skilled in the art can clearly learn that for the purposes of convenience and conciseness of description, reference may be made to the corresponding processes in the aforementioned method embodiments as to the specific working processes of the above-described systems, devices and modules, which are not redundantly described herein.

In the several embodiments provided by the present disclosure, it should be understood that the disclosed systems, devices and methods may be realized in other ways. For example, the above-described device embodiments are only schematic, for example, the division of the modules is only a logical function division, and can have additional division ways in practice, for example, a plurality of modules or components may be combined or integrated to the other system, or some features may be ignored or not executed. In addition, the displayed or discussed mutual coupling or direct coupling or communication connection may be realized by indirect coupling or communication connection of some interfaces, devices or modules, and may be in electrical, mechanical or other forms.

The modules illustrated as separate components may be or may not be physically separated, and the components displayed as modules may be or may not be physical modules, that is to say, the components may be positioned at one place or may also be distributed on a plurality of network units. The objectives of the solutions of the embodiments may be fulfilled by selecting part of or all of the modules according to actual needs.

In addition, the functional modules in the embodiments of the present disclosure may be integrated in one processing unit, or the modules exist separately and physically, or two or more modules are integrated in one unit. The integrated unit may be realized in the form of hardware or in the form of hardware and software functional units.

The integrated unit realized in the form of software functional units may be stored in a computer readable storage medium. The software functional units are stored in one storage medium, which includes a plurality of instructions enabling a computer device (which may be a personal computer, a server, or a network device or the like) or a processor to execute part of the steps of the method in each embodiment of the present disclosure. The aforementioned storage medium includes various media capable of storing program codes, such as a U disk, a mobile hard disk, a read-only memory (ROM), a random access memory (RAM), a magnetic disk or an optical disk.

The above descriptions are merely preferred embodiments of the present disclosure, and are not used for limiting the present disclosure. Any modification, equivalent substitution, improvement and the like made within the spirit and principle of the present disclosure shall be included within the protection scope of the present disclosure.

What is claimed is:

1. A method for adjusting multimedia, applied to a mobile device, comprising:
detecting an operation information of a user at an edge touch area of a side border of the mobile device in a state that the mobile device plays multimedia;
analyzing a multimedia adjusting instruction corresponding to the detected operation information according to a preset corresponding relation between the operation information and the multimedia adjusting instruction; and
adjusting the multimedia according to the analyzed multimedia adjusting instruction.

2. The method for adjusting multimedia according to claim 1, wherein the adjusting the multimedia according to the analyzed multimedia adjusting instruction comprises:
adjusting a volume of the multimedia according to the analyzed multimedia adjusting instruction, adjusting a brightness of a screen for displaying the multimedia according to the analyzed multimedia adjusting instruction, or adjusting a screen display size of the multimedia according to the analyzed multimedia adjusting instruction.

3. The method for adjusting multimedia according to claim 1, further comprising:
presetting the corresponding relation between the operation information and the multimedia adjusting instruction.

4. The method for adjusting multimedia according to claim 1, before analyzing a multimedia adjusting instruction corresponding to the detected operation information according to a preset corresponding relation between the operation information and the multimedia adjusting instruction, the method further comprises:
judging a current screen direction of the mobile device, wherein the screen direction comprises a landscape screen direction and a portrait screen direction; and
selecting, according to a judgment result, a corresponding relation between the operation information and the multimedia adjusting instruction corresponding to the current screen direction as an analysis basis.

5. The method for adjusting multimedia according to claim 1, wherein the operation information is clicking at a preset position or pressing at the preset position, or sliding.

6. The method for adjusting multimedia according to claim 1, wherein the multimedia is video, audio, pictures or characters.

7. A mobile device, comprising:
a processor; and
a memory, used for storing instructions executable by the processor; wherein
the processor is configured to:
detect an operation information of a user at an edge touch area of a side border of the mobile device in a state that the mobile device plays multimedia;
analyze a multimedia adjusting instruction corresponding to the detected operation information according to a preset corresponding relation between the operation information and the multimedia adjusting instruction; and
adjust the multimedia according to the analyzed multimedia adjusting instruction.

8. The mobile device according to claim 7, wherein the mobile device is a mobile phone or a tablet computer.

9. The mobile device according to claim 7, wherein the adjusting the multimedia according to the analyzed multimedia adjusting instruction comprises:
adjusting a volume of the multimedia according to the analyzed multimedia adjusting instruction, adjusting a brightness of a screen for displaying the multimedia according to the analyzed multimedia adjusting instruction, or adjusting a screen display size of the multimedia according to the analyzed multimedia adjusting instruction.

10. The mobile device according to claim 7, wherein the processor is further configured to:
preset the corresponding relation between the operation information and the multimedia adjusting instruction.

11. The mobile device according to claim 7, before analyzing a multimedia adjusting instruction corresponding to the detected operation information according to a preset corresponding relation between the operation information and the multimedia adjusting instruction, the method further comprises:
judging a current screen direction of the mobile device, wherein the screen direction comprises a landscape screen direction and a portrait screen direction; and
selecting, according to a judgment result, a corresponding relation between the operation information and the multimedia adjusting instruction corresponding to the current screen direction as an analysis basis.

12. The mobile device according to claim 7, wherein the operation information is clicking at a preset position or pressing at the preset position, or sliding.

13. The mobile device according to claim 7, wherein the multimedia is video, audio, pictures or characters.

14. A non-transient computer readable storage medium, wherein the non-transient computer readable storage medium stores computer executable instructions, which are used for:
detecting an operation information of a user at an edge touch area of a side border of the mobile device in a state that the mobile device plays multimedia;
analyzing a multimedia adjusting instruction corresponding to the detected operation information according to a preset corresponding relation between the operation information and the multimedia adjusting instruction; and
adjusting the multimedia according to the analyzed multimedia adjusting instruction.

15. The non-transient computer readable storage medium according to claim 14, wherein the adjusting the multimedia according to the analyzed multimedia adjusting instruction comprises:
adjusting a volume of the multimedia according to the analyzed multimedia adjusting instruction, adjusting a brightness of a screen for displaying the multimedia according to the analyzed multimedia adjusting instruction, or adjusting a screen display size of the multimedia according to the analyzed multimedia adjusting instruction.

16. The non-transient computer readable storage medium according to claim 14, wherein the computer executable instructions are further used for:
presetting the corresponding relation between the operation information and the multimedia adjusting instruction.

17. The non-transient computer readable storage medium according to claim 14, before analyzing a multimedia adjusting instruction corresponding to the detected operation information according to a preset corresponding relation between the operation information and the multimedia adjusting instruction, the method further comprises:
judging a current screen direction of the mobile device, wherein the screen direction comprises a landscape screen direction and a portrait screen direction; and
selecting, according to a judgment result, a corresponding relation between the operation information and the multimedia adjusting instruction corresponding to the current screen direction as an analysis basis.

18. The non-transient computer readable storage medium according to claim 14, wherein the operation information is clicking at a preset position or pressing at the preset position, or sliding.

19. The non-transient computer readable storage medium according to claim 14, wherein the multimedia is video, audio, pictures or characters.
